(19) United States
(12) Patent Application Publication
(10) Pub. No.: US 2002/0108281 A1
(43) Pub. Date: Aug. 15, 2002

(54) Simulated motion display device

(76) Inventor: Andrew Mauck, Elkgrove, CA (US)

Correspondence Address: W. Eric Boyd, Esq., 39 Albergar, San Clemente, CA, 92672, US

(21) Appl. No.: 09/737,981

(22) Filed: Dec. 18, 2000

(51) Int. Cl. G09F 19/14

(52) U.S. Cl. 40/453

(57) ABSTRACT

A display device for simulating motion from a two-dimensional image is provided. The image may be in two-point or three-point perspective. A first planar surface and a second planar surface with a single image imposed thereon are angularly disposed to each other. The vertical intersection of the first and second planar surfaces is coincident with the foreground of the image.

The device is positioned so that the intersection is recessed from the intended viewer. An optional frame for use with the device is provided. When a viewer moves at right angles to the device, the varying angle between the viewer and the image changes the perceived width of each surface, causing apparent rotation of the image to the viewer.

### BACKGROUND OF THE INVENTION

A. Field of the Invention

The subject of the invention relates to display devices or systems such as the type generally used in static two-dimensional display advertising. More specifically, the invention is directed to a display device which uses an optical illusion of perceived movement to attract the attention of a consumer or viewer.

Display advertising has been available for many years and frequently utilizes flat vertical panels such as sheets of cardboard or plastic, billboards and the like. The function of such advertising displays is to catch the consumer'ss attention and promote the product or service being advertised by creating an impression in the mind of the viewer. The widespread use of such display advertising suggests that it has been and will continue to be a successful method for promoting a product or service due to its relatively low cost and ease of implementation.

It is desirable to place advertising displays in locations where the consumer or targeted audience has a high likelihood of noticing and reading the ad. It is also desirable to provide advertising displays that increase the chance a consumer'ss attention will be drawn to the display by its appearance or content. Unfortunately, due to the popularity of flat panel advertising, consumers are saturated with all forms of advertising display systems, thus limiting the amount of attention focused on any particular panel display.

Accordingly, advertisers are continually developing new advertising methods which will attract the attention of the consuming public. Bright colors, sex appeal, controversy and motion have all been used with success in the advertising display industry. The instant invention capitalizes on the use of motion in displays to attract the attention of the viewing public.

B. Discussion of the Prior Art

It is well understood that motion tends to attract the attention of consumers. Therefore many advertisers have incorporated various forms of motion in display advertising. Unfortunately, the cost associated with motion-based advertising methods is high. Any form of electronic display such as video necessarily includes a power supply and electronic display tube and related circuitry. Mechanical motion display devices generally include some form of reciprocal or rotational motion, requiring a power supply and moving parts which wear or can be damaged.

Both of these forms of motion-based advertising have additional undesirable characteristics when applied to a billboard or large-scale display. If a large motion display is desired on a billboard, the cost of electronic display components becomes almost prohibitive, especially at locations where power is unavailable or where the environment is harsh. Large amounts of power and bulky devices are necessary for a large mechanical motion based display.

Accordingly, the need has arisen for advertising display device which will attract the attention of the consumer in an environment where other advertising display systems are in use. Further, the need has arisen for a device which will appear to have motion but does not require a power supply, electronic display or moving parts. Further, the need has arisen for such a device which is low in cost and can be readily used in small applications such as in-store displays and large-scale applications such as outdoor advertising billboards.

### BRIEF SUMMARY OF THE INVENTION

The purpose of the present invention, which shall be described subsequently in greater detail, is to provide an advertising display panel that simulates motion for which there are many novel features which are not anticipated, rendered obvious, suggested or even implied by any prior art advertising display device either alone or in combination.

In accordance with the present invention, a display device is provided. An image, such as a photograph or drawing, is imposed on the surface of a planar substrate. The foreground of the image is preferably located on the central vertical axis of the substrate. The preferred embodiment includes an image presented in two or three point perspective upon the substrate. The perspective lines of the image are on the surface of each opposing plane are visually projected away from the intended viewer The planar substrate is divided into two substantially equal planar surfaces, coincident with the central vertical axis of the substrate. The two planar surfaces are angularly disposed to one another at an angle of preferably 90 degrees or less. The device may be mounted within a frame so that to the apparent intersection of the planar surfaces is recessed centrally within the frame from the viewer'ss perspective. The planar surfaces may optionally be curved so as to be arcuate in cross-section, i.e. convex to the viewer, rather than in a V-type cross-section.

The operation of the device is as follows. Typically, the display of three-dimensional objects is represented on a two-dimensional flat surface. In the instant invention, an image is transferred onto a bent or curved surface, changing the geometric form of the surface of the image. As a result, movement of the viewer relative to the image produces the illusion that the image thereon is rotating. The movement is relative and can be produced by having the viewer move or by moving the device itself.

As a viewer moves perpendicular to the image, a change in the perceived width of the two sides of the image occurs. This is because the two sides of the surface are set at different angles to the viewer. Movement of the viewer causes the angle between the viewer and the image on the planar surfaces to change relative to the position of the viewer. The size of the perceived image also changes with the movement of the viewer. The change in the perceived width of the two sides is translated by the brain into a rotation which in fact is not occurring.

Because of the apparent perspective of the image on the opposing planar surfaces, the relative motion of viewers as they pass by the display produces the illusion of three-dimensional object which appears to rotate. The viewer perceives a rotating three-dimensional object within a two-dimensional plane. This creates the opportunity for subconscious visual confusion in which an “impossible figure” is created in the mind of the viewer. This occurs because it takes a distinct mental effort to realize the eye has been tricked by the display image. As a result, attention is devoted toward the simulated motion display device, attracting the viewer'ss attention toward whatever good or service is promoted thereon.

Accordingly, an object of the instant invention to overcome the limitations of previous advertising display panels presently in use and to provide a device which will attract the consumers attention by simulating motion. It is a further object of the instant invention to provide a simulated motion advertising panel that is simple to manufacture and use, inexpensive to construct and requires little or no maintenance.

These, together with other objects of the invention, along with the various features of novelty which characterize the invention, are pointed out with particularity in the claims annexed to and forming a part of this disclosure. For better understanding of the invention, its operating advantages and the specific objects attained by its uses, reference should be made to the accompanying drawings and descriptive matter in which there is illustrated a preferred embodiment of the invention.

There has thus been outlined, rather broadly, the more important features of the invention in order that the detailed description which follows may be better understood and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings.

The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods and systems for carrying out the several purposes of the present invention.

It is important, therefore, that the claims be regarded as including such equivalent constructions insofar as they do not depart from the spirit and scope of the present invention.

Further, the purpose of the foregoing summary is to enable the U.S. Patent and Trademark Office and the public generally, especially engineers and practitioners in the art who are not familiar with patent or legal terms or phraseology, to determine quickly from a cursory inspection, the nature and essence of the technical disclosure of the application.

The summary is neither intended to define the invention of the application, which is measured by the claims, nor is intended to be limiting as to the scope of the invention in any way.

RELATED ART

| | |
|---|---|
| 5,483,762: | Hogan |
| 5,265,360: | Reiss et al. |
| 4,255,380: | Bjorkland |
| 2,711,039: | Wittman |
| 1,718,333: | Coria |

While these patents were found in a comprehensive search performed at the United States Patent and Trademark Office, none discloses any structure or operation as claimed herein.

### BRIEF DESCRIPTION OF THE DRAWINGS

The invention is further described in connection with the accompanying drawings in which:

FIG. 1 is a perspective view of a preferred embodiment of the display device mounted in a frame, constructed in accordance with the teachings of the present invention;

FIG. 2 is a front view of the preferred embodiment of FIG. 1;

FIG. 3 is a top view of a preferred embodiment of the present invention shown, mounted in a frame;

FIG. 4 is a top view of an alternative preferred embodiment of the present invention showing the use of curved planar surfaces mounted in a frame.

### DETAILED DESCRIPTION OF THE INVENTION

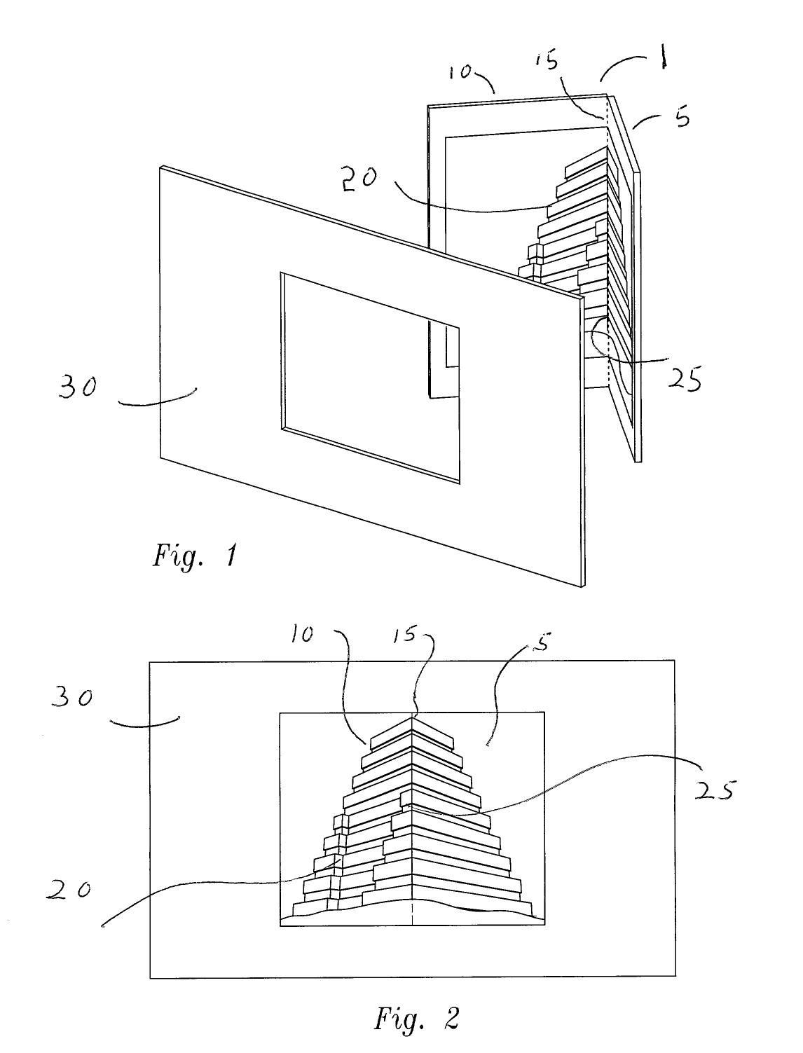

Turning now to the drawings wherein like numerals designate like elements throughout the several views, FIGS. 1 and 2 show a preferred embodiment of the subject simulated motion display device 1. Display device 1 includes a first planar surface 5 and a second planar surface 10. First planar surface 5 and second planar surface 10 are angularly disposed to one another along vertical axis 15, at the apparent intersection thereof.

A two-dimensional image 20 is imposed across first planar surface 5 and second planar surface 10. Image 20 is preferably provided in two-point or three-point perspective.

The forwardmost portion of image 20, herein referred to as the foreground 25, is coincident with vertical axis 15. Vertical axis 15 is preferably provided so that first planar surface 5 and second planar surface 10 are approximately equal in surface area on either side of vertical axis 15, but may be provided at any location so long as vertical axis 15 is coincident with foreground 25.

First planar surface 5 and second planar surface 10 are preferably disposed at an angle of 90 degrees, but may be disposed at any angle. It is noted the simulated motion effect intended by display device 1 tends to diminish as the angular disposition of the first and second planar surfaces becomes substantially greater than or substantially less than 90 degrees.

A preferred method of manufacture of display device 1 is to impose image 20 on a single flat substrate such as foam core or cardboard and create a vertical score line to facilitate a bend or break along vertical axis 15 so as to easily create first planar surface 5 and second planar surface 10 from a single piece of material.

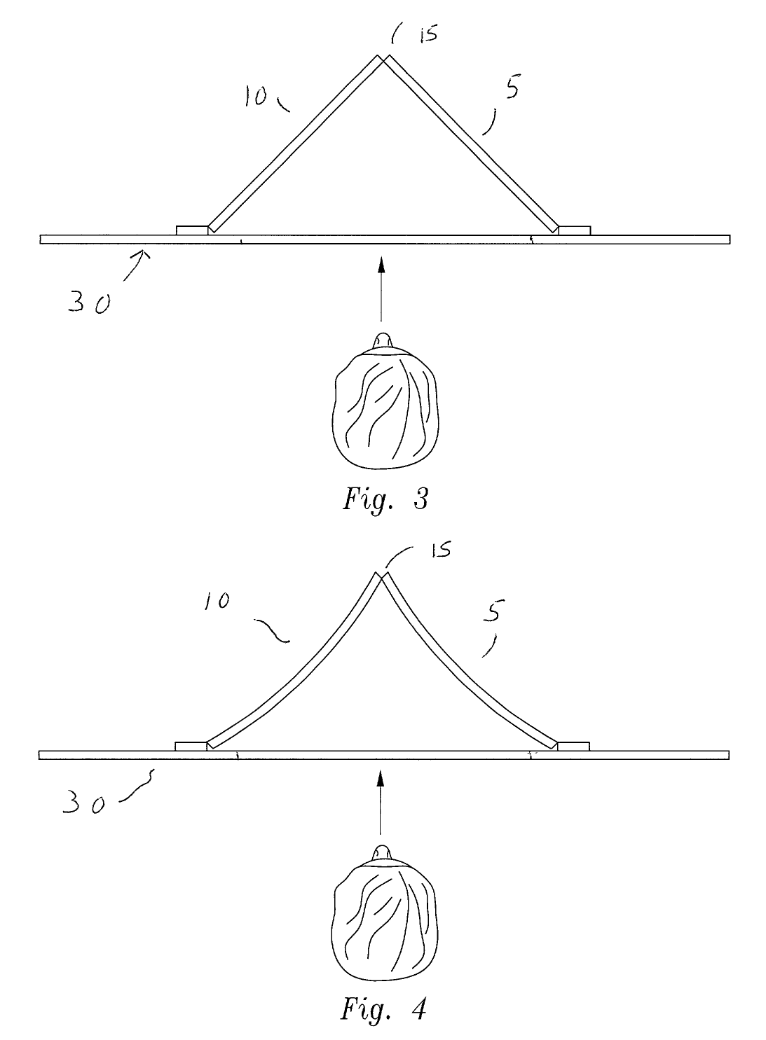

As further illustrated in FIG. 3, the preferred embodiment includes a flat frame 30 mounted so that the periphery of display device 1 is hidden from view and so that vertical axis 15 is recessed from frame 30. The use of frame 30 additionally facilitates the stability of display device 1 when it is set on a surface such as a store counter.

An alternative preferred embodiment, shown in FIG. 4, utilizes curved first and second planar surfaces.

It can therefore be seen that the present disclosure provides a unique display device which is both inexpensive to make and requires minimal maintenance. Moreover, having thus described the invention, it should also be apparent that numerous structural modifications and adaptations maybe resorted to without departing from the scope and fair meaning of the instant invention as set forth above.

With respect to the above description then, it is also to be realized that optimum dimensional relationships for the parts of the disclosed invention, to include variations in size, materials, shape, form, the function and manner of operation, assembly and use, are deemed readily apparent and obvious to those skilled in the graphic arts. All equivalent relationships to those illustrated in the drawings and described in the specification are intended to be encompassed by the present invention.

Accordingly, the foregoing is considered illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of invention.

I claim:

1. A simulated motion display device comprised of:
a first planar surface and a second planar surface,
said first and second planar surfaces angularly disposed to one another along a vertical axis,
an image imposed upon said first and second planar surfaces whereby the foreground of said image is coincident with said central vertical axis.

2. The device of claim 1 wherein said image is provided in two-point perspective.

3. The device of claim 1 wherein said image is provided in three-point perspective.

4. The device of claim 1 wherein said first and second planar surfaces are angularly disposed at an angle greater than 90 degrees.

5. The device of claim 1 wherein said first and second planar surfaces are angularly disposed at an angle of less than 90 degrees.

6. The device of claim 1 wherein said first and second planar surfaces are angularly disposed at 90 degrees.

7. The device of claim 1 whereby said first planar surface and said second planar surface are formed from a single substrate.

8. The device of claim 1 wherein said first and second planar surfaces are convex.

9. The device of claim 1 wherein said display device is mounted on a frame so as to allow said image to be viewed and whereby said foreground is recessed from said frame.
